(19) United States
(12) Patent Application Publication
(10) Pub. No.: US 2020/0241869 A1
(43) Pub. Date: Jul. 30, 2020

(54) Cloud Software Development Kit for Third-Party Autonomous Vehicles

(71) Applicant: Uber Technologies, Inc., San Francisco, CA (US)

(72) Inventors: Konrad Julian Niemiec, Mountain View, CA (US); Andrii Iasynetskyi, Millbrae, CA (US); Jay A. Chen, Freemont, CA (US); Matthew James Way, Pittsburgh, PA (US); Mark Yen, San Francisco, CA (US); Michael Voznesensky, San Francisco, CA (US); Vladimir Zaytsev, San Francisco, CA (US); Brent Justin Goldman, San Francisco, CA (US)

(21) Appl. No.: 16/526,079

(22) Filed: Jul. 30, 2019

Related U.S. Application Data
(60) Provisional application No. 62/796,974, filed on Jan. 25, 2019.

(51) Int. Cl. G06F 8/65; H04L 29/06; G06F 8/10; H04W 4/40

(52) U.S. Cl. CPC G06F 8/65; H04W 4/40; G06F 8/10; H04L 63/0823

(57) ABSTRACT

Systems and methods for enabling communication between a service entity and third-party autonomous vehicles are provided. A method can include accessing, by a first computing system associated with a third-party entity, a software package stored within the first computing system. The software package can be associated with a service entity that coordinates a vehicle service for the one or more autonomous vehicles. The method can further include establishing, by the first computing system via the software package, a communication connection with a second computing system that is associated with the service entity. The second computing system can include one or more backend services to facilitate the vehicle service. The method can further include communicating, between the first computing system and the second computing system, data indicative of a communication associated with the one or more autonomous vehicles via the communication connection.

### PRIORITY CLAIM

The present application is based on and claims benefit of U.S. Provisional Application 62/796,974 having a filing date of Jan. 25, 2019, which is incorporated by reference herein.

### FIELD

The present disclosure relates generally to devices, systems, and methods for enabling communication between a service entity and third-party entity and/or third-party autonomous vehicles.

### BACKGROUND

An autonomous vehicle is a vehicle that is capable of sensing its environment and navigating with minimal or no human input. In particular, an autonomous vehicle can observe its surrounding environment using a variety of sensors and can attempt to comprehend the environment by performing various processing techniques on data collected by the sensors. Given knowledge of its surrounding environment, the autonomous vehicle can identify an appropriate motion path through such surrounding environment.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for communication between a service entity and a third-party entity. The method can include accessing, by a first computing system comprising one or more computing devices, a software package stored within the first computing system. The first computing system can be associated with a third-party entity. The third-party entity can be associated with one or more autonomous vehicles. The software package can be associated with a service entity that coordinates a vehicle service for the one or more autonomous vehicles. The method can further include establishing, by the first computing system via the software package, a communication connection with a second computing system that is associated with the service entity. The second computing system can include one or more backend services to facilitate the vehicle service. The method can further include communicating, between the first computing system and the second computing system, data indicative of a communication associated with the one or more autonomous vehicles via the communication connection.

Another example aspect of the present disclosure is directed to a communication system for enabling communication between a service entity and an autonomous vehicle associated with a third-party entity. The communication system can include a first computing system associated with the third-party entity. The first computing system can include one or more processors and one or more memory devices and software package associated the service entity. The communication system can further include a second computing system associated with the service entity. The second computing system can include one or more processors and one or more memory devices. The second computing system can further include a vehicle integration platform comprising a plurality of application programming interfaces. Each of the plurality of application programming interfaces can be configured to provide one or more backend services to facilitate one or more vehicle services. The first computing system can be configured to perform operations. The operations can include accessing the software package. The operations can further include establishing a communication connection between the first computing system and the second computing system via the software package. The operations can further include receiving a message from the vehicle integration platform via the communication connection. The message can include at least one vehicle identifier associated with at least one particular autonomous vehicle associated with the third-party entity. The operations can further include communicating the message to the at least one particular autonomous vehicle.

Another example aspect of the present disclosure is directed to a cloud-based software package for communication between a service entity and an autonomous vehicle associated with a third-party. The software package can include one or more tangible, non-transitory, computer-readable media that store instructions that when executed by one or more processors cause the one or more processors to perform operations. The operations can include receiving a message from the autonomous vehicle associated with the third-party entity. The operations can further include determining whether an open communication connection associated with the service entity and the autonomous vehicle is established. When the open communication connection associated with the service entity and the autonomous vehicle is established, the operations can further include transmitting, via the open communication connection, the message to the service entity. When the open communication connection associated with the service entity and the autonomous vehicle is not established, the operations can further include establishing, via the software package, a new communication connection associated with the service entity and the autonomous vehicle and transmitting, via the new communication connection, the message to the service entity.

Other aspects of the present disclosure are directed to various systems, apparatuses, non-transitory computer-readable media, vehicles, and computing devices.

The autonomous vehicle technology described herein can help improve the safety of passengers of an autonomous vehicle, improve the safety of the surroundings of the autonomous vehicle, improve the experience of the rider and/or operator of the autonomous vehicle, as well as provide other improvements as described herein. Moreover, the autonomous vehicle technology of the present disclosure can help improve the ability of an autonomous vehicle to effectively provide vehicle services to others and support the various members of the community in which the autonomous vehicle is operating, including persons with reduced mobility and/or persons that are underserved by other transportation options. Additionally, the autonomous vehicle of the present disclosure may reduce traffic congestion in communities as well as provide alternate forms of transportation that may provide environmental benefits.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example system for controlling the navigation of an autonomous vehicle according to example aspects of the present disclosure;

FIG. 2 depicts a block diagram of an example communication system according to example aspects of the present disclosure;

FIG. 3 depicts a block diagram of an example communication system according to example aspects of the present disclosure;

FIG. 4 depicts an example method according to example aspects of the present disclosure;

FIG. 5 depicts an example method according to example aspects of the present disclosure;

FIG. 6 depicts an example method according to example aspects of the present disclosure;

FIG. 7 depicts an example system with units for performing operations and functions according to example aspects of the present disclosure; and

FIG. 8 depicts example system components according to example aspects of the present disclosure.

### DETAILED DESCRIPTION

Example aspects of the present disclosure are directed to improved techniques for facilitating two-way communication of autonomous vehicle information between a third-party entity and a service entity via a software package operating on the third-party entity's infrastructure (e.g., a cloud-based computing system infrastructure). For example, an autonomous vehicle can drive, navigate, operate, etc. with minimal and/or no interaction from a human driver to provide a vehicle service. By way of example, an autonomous vehicle can be configured to provide transportation and/or other services, such as transporting a user (e.g., passenger) from a first location to a second location. The user can request this transportation service with a service entity, which can create a service assignment for an autonomous vehicle. In some implementations, the service entity can utilize a third-party entity's fleet of autonomous vehicles to perform a service assignment. For example, the service entity can have an infrastructure that can allow the service entity to assign the service assignment to an autonomous vehicle of another entity's fleet (e.g., “a third-party autonomous vehicle”). Such an infrastructure can include a platform comprising one or more application programming interfaces (APIs) that are configured to allow third-party autonomous vehicles and provider infrastructure endpoints (e.g., system clients that provide backend services, etc.) to communicate. For example, a service entity infrastructure can include a “Public” Vehicle Integration Platform (VIP) which can facilitate communication between the service entity and a third-party entity's backend, and ultimately to third-party autonomous vehicles. The software package can be a Cloud Software Development Kit (SDK) operating on the third-party entity's infrastructure, which can facilitate the use of a specific environment, such as the Public VIP. For example, the Cloud SDK can aid the delivery of the service assignment to third-party autonomous vehicles, monitor and communicate vehicle progress, provide remote assistance, etc. and, ultimately, to support the performance of a service assignment by the third-party autonomous vehicles. Further, the Cloud SDK can facilitate the communication of information about one or more third-party autonomous vehicles to the service entity.

The systems and methods of the present disclosure provide improved techniques to efficiently communicate information between a third-party entity (and/or a third-party autonomous vehicle) and a service entity. For example, the systems and methods of the present disclosure help ensure that third-party autonomous vehicles are able to properly receive and complete service assignments (e.g., transporting a user from one location to another) as well as communicate with the infrastructure endpoints (e.g., backend services). To do so, the infrastructure can include a Cloud SDK that is configured to enable communication between a service entity's backend (e.g., via a Public VIP) and the backend of the third-party entity. For example, in some implementations, the Cloud SDK can batch a plurality of calls (e.g., service assignments, status updates, etc.) into a single communication between the service entity's backend and the third-party entity's backend. In this way, the technology of the present disclosure can allow for more efficient communication between a service entity and a third-party entity.

More particularly, a service entity (e.g., service provider, owner, manager, platform) can use one or more vehicles (e.g., ground-based vehicles) to provide a vehicle service such as a transportation service (e.g., rideshare service), a courier service, a delivery service, etc. For example, the service entity (e.g., its operations computing system) can receive requests for vehicle services (e.g., from a user) and generate service assignments (e.g., indicative of the vehicle service type, origin location, destination location, and/or other parameters) for the vehicle(s) to perform. The vehicle(s) can be autonomous vehicles that include various systems and devices configured to control the operation of the vehicle. For example, an autonomous vehicle can include an onboard vehicle computing system for operating the autonomous vehicle (e.g., located on or within the autonomous vehicle). The vehicle computing system can obtain sensor data from sensor(s) onboard the vehicle (e.g., cameras, LIDAR, RADAR, etc.), attempt to comprehend the vehicle's surrounding environment by performing various processing techniques on the sensor data, and generate an appropriate motion plan through the vehicle's surrounding environment. Moreover, an autonomous vehicle can be configured to communicate with one or more computing devices that are remote from the vehicle. For example, the autonomous vehicle can communicate with a remote computing system that can be associated with the service entity, such as the service entity's operations computing system, and/or a remote computing system associated with a third-party entity, such as a third-party entity's computing system. The service entity's operations computing system can include a plurality of system clients that can help the service entity monitor, communicate with, manage, etc. autonomous vehicles. In this way, the service entity can manage the autonomous vehicles to provide the vehicle services of the entity.

The autonomous vehicles utilized by the service entity to provide the vehicle service can be associated with a fleet of a third-party. For example, an autonomous vehicle can be associated with a third-party entity such as, for example, an individual, an original equipment manufacturer (OEM), or another entity (e.g., a “third-party autonomous vehicle”). Even though such an autonomous vehicle may not be included in the fleet of autonomous vehicles of the service entity, the platforms of the present disclosure can allow such a third-party autonomous vehicle to still be utilized to provide the vehicles services offered by the service entity, access its system clients, etc.

For example, a service entity's infrastructure (e.g., the entity's operations computing system) can include a Public VIP and a Private VIP to facilitate services between the service entity infrastructure and autonomous vehicles. For example, the Public VIP can facilitate access to backend services (e.g., provided by backend system clients) by autonomous vehicles associated with one or more third-party entities (and/or the service entity's own fleet). The Public VIP can provide access to services such as service assignment services, routing services, supply positioning services, payment services, remote assist services, and/or the like. The Private VIP can provide access to services that are specific to the service entity's autonomous vehicle fleet such as fleet management services, autonomy assistance services, and/or the like. Both the Public and the Private VIPs can each include a gateway API to facilitate communication from the autonomous vehicles to the provider backend infrastructure services (e.g., backend system clients, etc.) and a vehicle API to facilitate communication from the provider backend infrastructure services to the autonomous vehicles. Each of the platform's APIs can have separate responsibilities, monitoring, alerting, tracing, service level agreements (SLAs), and/or the like.

A third-party entity's infrastructure (e.g., the third-party entity's computing system) can include entity-specific platforms for communicating service requests to autonomous vehicles in the third-party entity's fleet, and further, for performing the service assignments. For example, a third-party entity may develop and implement entity-specific communication and/or privacy protocols for communicating between the entity's infrastructure and autonomous vehicles in the third-party entity's fleet. Similarly, a third-party entity may develop and implement entity-specific vehicle monitoring protocols in order to manage the third-party's fleet of autonomous vehicles. As an example, the third-party entity may monitor various attributes of a third-party autonomous vehicle (e.g., data indicative of the status of the autonomous vehicle) via a third-party entity-specific platform while the third-party autonomous vehicle performs service assignments. Moreover, a third-party entity may use a third-party entity-specific format for performing autonomous vehicle services. As an example, a third-party entity may implement a third-party entity specific protocol for communication between the third-party entity and the autonomous vehicles in the third-party entity's fleet.

According to example aspects of the present disclosure, a Cloud SDK can be implemented on a third-party entity's infrastructure (e.g., the third-party entity's backend) to allow for efficient communication between a service entity (e.g., a service entity's backend, the Public VIP, etc.) and third-party autonomous vehicles. The Cloud SDK can include a gateway API to facilitate communication from the service entity's backend to the third-party entity's infrastructure. For example, the service entity can provide the Cloud SDK to the third-party entity as a software package for the third-party entity to integrate into the third-party entity's infrastructure. In some implementations, the Cloud SDK can be implemented in a C++ library with C++, Go, Java, and/or other coding language interfaces/bindings exposed to allow for simplified integration into the third-party entity's backend.

In some implementations, the Cloud SDK can include a core layer and a business layer. The core layer can be configured to establish communication connections between the service entity's infrastructure and the third-party entity's infrastructure. As an example, the core layer can implement one or more security protocols and/or communication protocols to allow for data to be transferred between the service entity's backend and the third-party entity's infrastructure (e.g., a backend associated therewith). The business layer can be configured to communicate other data, such as service requests, vehicle state data (e.g., whether one or more vehicles are online, offline, etc.), calls (e.g., actions for a specific autonomous vehicle, such as itinerary updates, trip offers, trip cancellations, etc.), callbacks (e.g., periodic location/position updates, etc.), and/or other data. In some implementations, the business layer can include different sets of components depending on the needs of a particular third-party entity. For example, various backend services can be implemented in a business layer, and can be tailored to a third-party entity's specific preferences.

In some implementations, a call (e.g., an action for a specific vehicle) can be communicated from the service entity's backend to the Cloud SDK implemented on the third-party entity's infrastructure, and can include a vehicle identifier (VID) to designate which autonomous vehicle in the third-party entity's fleet is to perform the action. As an example, each autonomous vehicle in a third-party entity's fleet can be assigned a unique VID, and the VID can be included with the call. In some implementations, each call can be communicated individually, such as when a service entity sends a service request or an itinerary update to a particular third-party autonomous vehicle.

According to example aspects of the present disclosure, the Cloud SDK can also batch a plurality of messages (e.g., calls, callbacks, etc.). For example, some communications may be recurring actions which are performed periodically at regular intervals. For example, a plurality of third-party autonomous vehicles in a third-party entity's fleet may provide periodic location updates (e.g., every four seconds) to the service entity. For example, in some implementations, each third-party autonomous vehicle performing a service assignment may provide a “callback” to the service entity which includes the respective third-party autonomous vehicle's location. The Cloud SDK can be configured to obtain the plurality of callbacks, and batch the callbacks into a single communication from the Cloud SDK to the service entity. For example, the batched location updates can be represented as a map of VIDs. An advantage provided by batching a plurality of callbacks is that a single, efficient data transmission can be communicated, rather than a plurality of individual transmissions. Further, by reducing the number of transmissions, the likelihood of a dropped or failed transmission of any single communication can be reduced.

Similarly, other calls, such as third-party entity driven actions, can be batched by the Cloud SDK. For example, a third-party entity may decide to take its entire fleet (or a portion thereof) online or offline. The Cloud SDK can send a single call to the service entity, which can include the batched actions taking the affected vehicles online or offline. As an example, when an entire fleet of third-party autonomous vehicles are taken online or offline, the Cloud SDK can send a single call indicative of such (e.g., a call indicating the entire fleet is going offline). As another example, when a portion of a third-party entity's fleet is taken online or offline, the batched call can include the action and the VIDs for the affected third-party autonomous vehicles. In some implementations, the Cloud SDK can communicate the batched messages to the service entity. For example, the Cloud SDK can send the batched messages to the Public VIP in the service entity's backend. In other implementations, the Cloud SDK can batch the actions, and make the batched actions available to be pulled (e.g., obtained) by the service entity.

In some implementations, the service entity can manage the state of one or more autonomous vehicles associated with the third-party entity. For example, the third-party entity may request that the service entity manage the state of the third-party entity's fleet of autonomous vehicles. The service entity can communicate a batched call to the third-party entity's backend via the Cloud SDK in order to manage the third-party entity's fleet of autonomous vehicles.

In some implementations, the Cloud SDK can act as a security delegate on behalf of third-party autonomous vehicles. As an example, in some implementations, the Cloud SDK can provide a digital signature on any communication sent on behalf of an individual third-party autonomous vehicle. For example, the Cloud SDK can obtain a “security handle” for each vehicle the Cloud SDK is communicating on behalf of. For example, the Cloud SDK can obtain a security certificate for each vehicle by acting as a registration authority (RA) and request the certificate from a certificate authority (CA). In some implementations, the Cloud SDK can obtain communications which can include a contextual indication when the Cloud SDK is acting as a security delegate. In some implementations, the Cloud SDK can receive one or more digitally signed communications from one or more third-party autonomous vehicles, and can then provide the digitally signed communications to the service entity.

In some implementations, the Cloud SDK can provide vehicle registration services for a third-party entity. As an example, a third-party entity can request a new vehicle be issued a security certificate (e.g., a digital registration) with appropriate clearances to perform service assignments via the Cloud SDK. For example, a request to register the new third-party autonomous vehicle can be communicated to the service entity via the Cloud SDK. As another example, a third-party entity can register the new vehicle by making the vehicle available via the Cloud SDK in response to a service request from the service entity. For example, the service entity can request a list of third-party autonomous vehicles available to perform a specific service assignment, and the Cloud SDK can include the new third-party autonomous vehicle in the list of fleet vehicles available to perform the service assignment.

The systems and methods described herein provide a number of technical effects and benefits. More particularly, the systems and methods of the present disclosure provide improved techniques for efficient communication and interfacing between a service entity and a third-party entity (or third-party autonomous vehicle). For example, a Cloud SDK operating on a third-party entity's backend infrastructure can establish a communication connection (e.g., a channel, a link, a session, etc.) between the backend of a service entity (or a Public VIP), including providing for various communication and security protocols, and enable communications between the service entity and the third-party entity. In this way, the service entity can send service requests, service assignments, itinerary updates, and other data to individual third-party autonomous vehicles while allowing the third-party entity to implement their own autonomous vehicle protocols. Further, the Cloud SDK can batch a plurality of communications into a single transmission, which can reduce redundancies in individual communications, increase overall efficiency of communications, and improve the reliability of such communications. Moreover, the Cloud SDK can use VIDs to identify and track individual third-party autonomous vehicles and related data, provide security certificates to verify and authenticate third-party autonomous vehicles and related data, and facilitate a variety of vehicle registration options. This leads to an improved integration of a third-party entity with a service entity's infrastructure, thereby increasing the pool of available autonomous vehicles for users and ultimately improving user experiences.

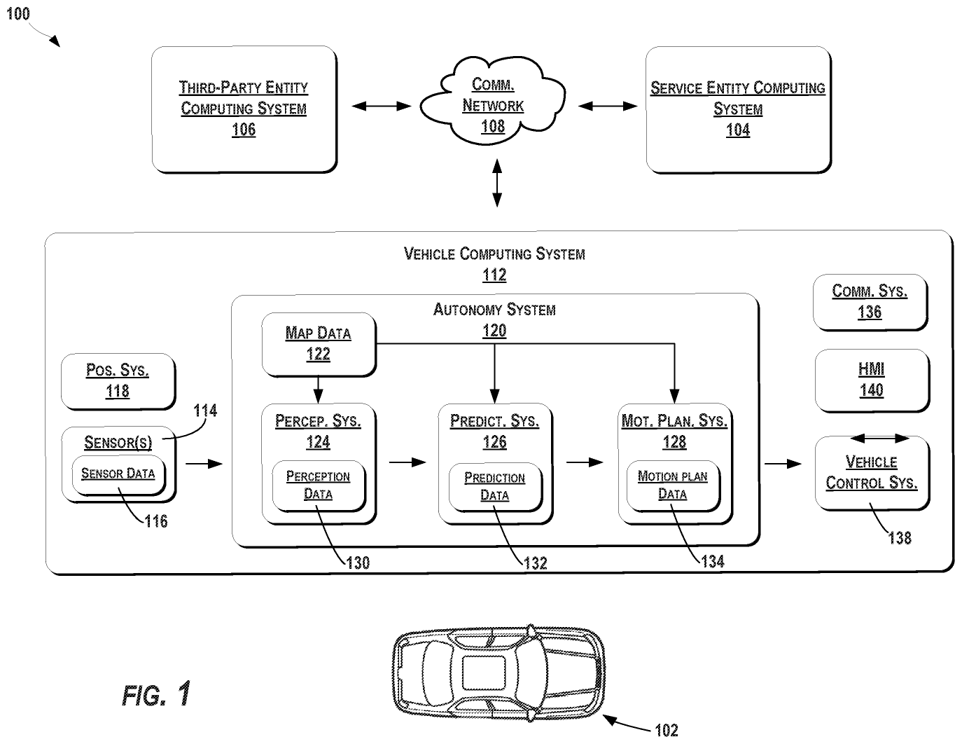

With reference now to the figures, example aspects of the present disclosure will be discussed in further detail. FIG. 1 depicts a block diagram of an example system 100 for controlling the navigation of a vehicle according to example aspects of the present disclosure. As illustrated, FIG. 1 shows a system 100 that can include a vehicle 102; a service entity computing system 104 (e.g., an operations computing system); one or more third-party entity computing systems 106; a communication network 108; a vehicle computing system 112; one or more autonomy system sensors 114; autonomy system sensor data 116; a positioning system 118; an autonomy computing system 120; map data 122; a perception system 124; a prediction system 126; a motion planning system 128; perception data 130; prediction data 132; motion plan data 134; a communication system 136; a vehicle control system 138; and a human-machine interface 140.

The service entity computing system 104 can be associated with a service entity (e.g., service provider) that can provide one or more vehicle services to a plurality of users via a fleet of vehicles that includes, for example, the vehicle 102. The vehicle services can include transportation services (e.g., rideshare services), courier services, delivery services, and/or other types of services. In some implementations, the vehicle 102 can be associated with the service entity, while in other implementations, the vehicle 102 can be associated with a third-party entity, such as a vendor or an OEM.

The service entity computing system 104 can include multiple components for performing various operations and functions. For example, the service entity computing system 104 can include and/or otherwise be associated with the one or more computing devices that are remote from the vehicle 102. The one or more computing devices of the service entity computing system 104 can include one or more processors and one or more memory devices. The one or more memory devices of the service entity computing system 104 can store instructions that when executed by the one or more processors cause the one or more processors to perform operations and functions associated with operation of one or more vehicles (e.g., a fleet of vehicles), with the provision of vehicle services, and/or other operations as discussed herein.

For example, the service entity computing system 104 can be configured to monitor and communicate with the vehicle 102 and/or its users to coordinate a vehicle service provided by the vehicle 102. To do so, the service entity computing system 104 can manage a database that includes data including vehicle status data associated with the status of vehicles including the vehicle 102. The vehicle status data can include a state of a vehicle, a location of a vehicle (e.g., a latitude and longitude of a vehicle), the availability of a vehicle (e.g., whether a vehicle is online or offline, available to pick-up or drop-off passengers and/or cargo, etc.), and/or the state of objects internal and/or external to a vehicle (e.g., the physical dimensions and/or appearance of objects internal/external to the vehicle).

The service entity computing system 104 can communicate with the one or more third-party entity computing systems 106 and/or the vehicle 102 via one or more communication networks including the communication network 108. The communication network 108 can exchange (send or receive) signals (e.g., electronic signals) or data (e.g., data from a computing device) and include any combination of various wired (e.g., twisted pair cable) and/or wireless communication mechanisms (e.g., cellular, wireless, satellite, microwave, and radio frequency) and/or any desired network topology (or topologies). For example, the communication network 108 can include a local area network (e.g. intranet), wide area network (e.g. Internet), wireless LAN network (e.g., via Wi-Fi), cellular network, a SATCOM network, VHF network, a HF network, a WiMAX based network, and/or any other suitable communication network (or combination thereof) for transmitting data to and/or from the vehicle 102.

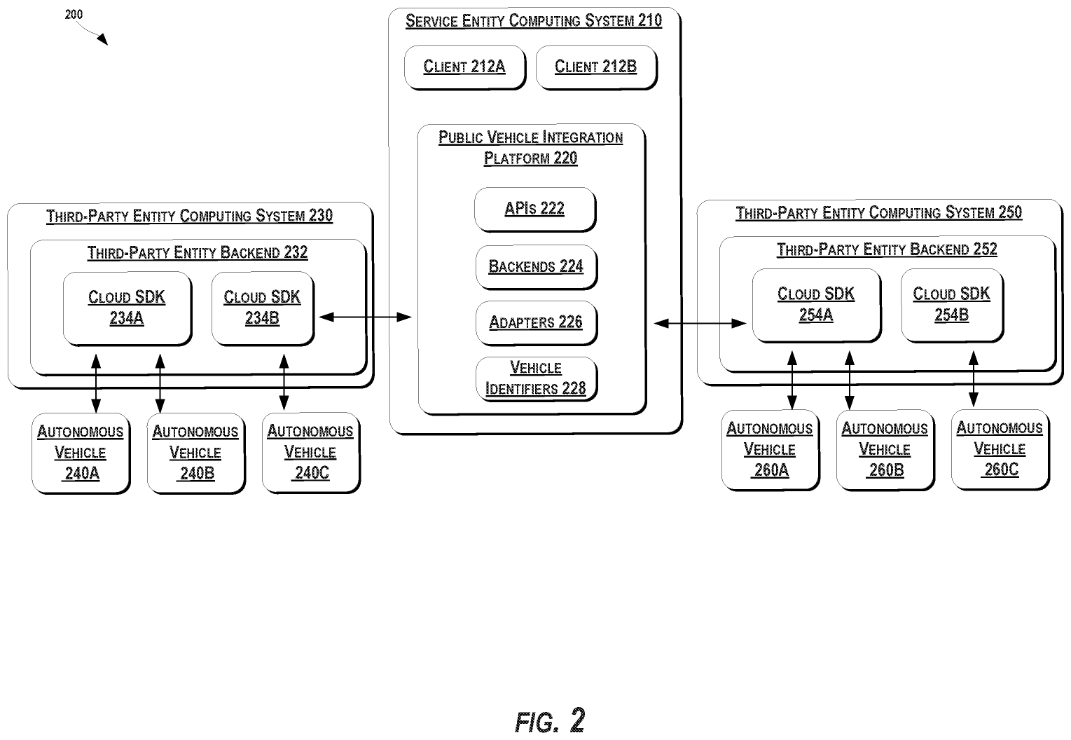

The third-party entity computing system 106 can include one or more processors and one or more memory devices. The one or more memory devices can be used to store instructions that when executed by the one or more processors of the one or more remote computing devise 106 cause the one or more processors to perform operations and/or functions including operations and/or functions associated with the vehicle 102 including exchanging (e.g., sending and/or receiving) data or signals with the vehicle 102, monitoring the state of the vehicle 102, and/or controlling the vehicle 102. The third-party entity computing system 106 can communicate (e.g., exchange data and/or signals) with one or more devices including the service entity computing system 104 and the vehicle 102 via the communication network 108. As will be discussed in greater detail with respect to FIG. 2, the third-party entity computing system 106 can include a software package, such as a software development kit (SDK), which can operate in a cloud-based environment in order to facilitate communication between the service entity computing system 104 and the vehicle 102.

The vehicle 102 can be a ground-based vehicle (e.g., an automobile), an aircraft, and/or another type of vehicle. The vehicle 102 can be an autonomous vehicle that can perform various actions including driving, navigating, and/or operating, with minimal and/or no interaction from a human driver. The autonomous vehicle 102 can be configured to operate in one or more modes including, for example, a fully autonomous operational mode, a semi-autonomous operational mode, a park mode, and/or a sleep mode. A fully autonomous (e.g., self-driving) operational mode can be one in which the vehicle 102 can provide driving and navigational operation with minimal and/or no interaction from a human driver present in the vehicle. A semi-autonomous operational mode can be one in which the vehicle 102 can operate with some interaction from a human driver present in the vehicle. Park and/or sleep modes can be used between operational modes while the vehicle 102 performs various actions including waiting to provide a subsequent vehicle service, and/or recharging between operational modes.

An indication, record, and/or other data indicative of the state of the vehicle, the state of one or more passengers of the vehicle, and/or the state of an environment including one or more objects (e.g., the physical dimensions and/or appearance of the one or more objects) can be stored locally in one or more memory devices of the vehicle 102. Additionally, the vehicle 102 can provide data indicative of the state of the vehicle, the state of one or more passengers of the vehicle, and/or the state of an environment to the service entity computing system 104 and/or the third-party entity computing system 106, which can store an indication, record, and/or other data indicative of the state of the one or more objects within a predefined distance of the vehicle 102 in one or more memory devices associated with the service entity computing system 104 (e.g., remote from the vehicle) and/or the third-party entity computing system. Furthermore, the vehicle 102 can provide data indicative of the state of the one or more objects (e.g., physical dimensions and/or appearance of the one or more objects) within a predefined distance of the vehicle 102 to the service entity computing system 104 and/or the third-party entity computing system 106, which can store an indication, record, and/or other data indicative of the state of the one or more objects within a predefined distance of the vehicle 102 in one or more memory devices associated with the service entity computing system 104 (e.g., remote from the vehicle) and/or the third-party entity computing system 106.

The vehicle 102 can include and/or be associated with the vehicle computing system 112. The vehicle computing system 112 can include one or more computing devices located onboard the vehicle 102. For example, the one or more computing devices of the vehicle computing system 112 can be located on and/or within the vehicle 102. The one or more computing devices of the vehicle computing system 112 can include various components for performing various operations and functions. For example, the one or more computing devices of the vehicle computing system 112 can include one or more processors and one or more tangible, non-transitory, computer readable media (e.g., memory devices). The one or more tangible, non-transitory, computer readable media can store instructions that when executed by the one or more processors cause the vehicle 102 (e.g., its computing system, one or more processors, and other devices in the vehicle 102) to perform operations and functions, including those described herein.

As depicted in FIG. 1, the vehicle computing system 112 can include the one or more autonomy system sensors 114; the positioning system 118; the autonomy computing system 120; the communication system 136; the vehicle control system 138; and the human-machine interface 140. One or more of these systems can be configured to communicate with one another via a communication channel. The communication channel can include one or more data buses (e.g., controller area network (CAN)), on-board diagnostics connector (e.g., OBD-II), and/or a combination of wired and/or wireless communication links. The onboard systems can exchange (e.g., send and/or receive) data, messages, and/or signals amongst one another via the communication channel.

The one or more autonomy system sensors 114 can be configured to generate and/or store data including the autonomy sensor data 116 associated with one or more objects that are proximate to the vehicle 102 (e.g., within range or a field of view of one or more of the one or more sensors 114). The one or more autonomy system sensors 114 can include a Light Detection and Ranging (LIDAR) system, a Radio Detection and Ranging (RADAR) system, one or more cameras (e.g., visible spectrum cameras and/or infrared cameras), motion sensors, and/or other types of imaging capture devices and/or sensors. The autonomy sensor data 116 can include image data, radar data, LIDAR data, and/or other data acquired by the one or more autonomy system sensors 114. The one or more objects can include, for example, pedestrians, vehicles, bicycles, and/or other objects. The one or more sensors can be located on various parts of the vehicle 102 including a front side, rear side, left side, right side, top, or bottom of the vehicle 102. The autonomy sensor data 116 can be indicative of locations associated with the one or more objects within the surrounding environment of the vehicle 102 at one or more times. For example, autonomy sensor data 116 can be indicative of one or more LIDAR point clouds associated with the one or more objects within the surrounding environment. The one or more autonomy system sensors 114 can provide the autonomy sensor data 116 to the autonomy computing system 120.

In addition to the autonomy sensor data 116, the autonomy computing system 120 can retrieve or otherwise obtain data including the map data 122. The map data 122 can provide detailed information about the surrounding environment of the vehicle 102. For example, the map data 122 can provide information regarding: the identity and location of different roadways, road segments, buildings, or other items or objects (e.g., lampposts, crosswalks and/or curb); the location and directions of traffic lanes (e.g., the location and direction of a parking lane, a turning lane, a bicycle lane, or other lanes within a particular roadway or other travel way and/or one or more boundary markings associated therewith); traffic control data (e.g., the location and instructions of signage, traffic lights, or other traffic control devices); and/or any other map data that provides information that assists the vehicle computing system 112 in processing, analyzing, and perceiving its surrounding environment and its relationship thereto.

The vehicle computing system 112 can include a positioning system 118. The positioning system 118 can determine a current position of the vehicle 102. The positioning system 118 can be any device or circuitry for analyzing the position of the vehicle 102. For example, the positioning system 118 can determine position by using one or more of inertial sensors, a satellite positioning system, based on IP/MAC address, by using triangulation and/or proximity to network access points or other network components (e.g., cellular towers and/or Wi-Fi access points) and/or other suitable techniques. The position of the vehicle 102 can be used by various systems of the vehicle computing system 112 and/or provided to one or more remote computing devices (e.g., the service entity computing system 104 and/or the remote computing device 106). For example, the map data 122 can provide the vehicle 102 relative positions of the surrounding environment of the vehicle 102. The vehicle 102 can identify its position within the surrounding environment (e.g., across six axes) based at least in part on the data described herein. For example, the vehicle 102 can process the autonomy sensor data 116 (e.g., LIDAR data, camera data) to match it to a map of the surrounding environment to get an understanding of the vehicle's position within that environment (e.g., transpose the vehicle's position within its surrounding environment).

The autonomy computing system 120 can include a perception system 124, a prediction system 126, a motion planning system 128, and/or other systems that cooperate to perceive the surrounding environment of the vehicle 102 and determine a motion plan for controlling the motion of the vehicle 102 accordingly. For example, the autonomy computing system 120 can receive the autonomy sensor data 116 from the one or more autonomy system sensors 114, attempt to determine the state of the surrounding environment by performing various processing techniques on the autonomy sensor data 116 (and/or other data), and generate an appropriate motion plan through the surrounding environment. The autonomy computing system 120 can control the one or more vehicle control systems 138 to operate the vehicle 102 according to the motion plan.

The perception system 124 can identify one or more objects that are proximate to the vehicle 102 based on autonomy sensor data 116 received from the autonomy system sensors 114. In particular, in some implementations, the perception system 124 can determine, for each object, perception data 130 that describes a current state of such object. As examples, the perception data 130 for each object can describe an estimate of the object's: current location (also referred to as position); current speed; current heading (which may also be referred to together as velocity); current acceleration; current orientation; size/footprint (e.g., as represented by a bounding shape such as a bounding polygon or polyhedron); class of characterization (e.g., vehicle class versus pedestrian class versus bicycle class versus other class); yaw rate; and/or other state information. In some implementations, the perception system 124 can determine perception data 130 for each object over a number of iterations. In particular, the perception system 124 can update the perception data 130 for each object at each iteration. Thus, the perception system 124 can detect and track objects (e.g., vehicles, bicycles, pedestrians, etc.) that are proximate to the vehicle 102 over time, and thereby produce a presentation of the world around an vehicle 102 along with its state (e.g., a presentation of the objects of interest within a scene at the current time along with the states of the objects).

The prediction system 126 can receive the perception data 130 from the perception system 124 and predict one or more future locations and/or moving paths for each object based on such state data. For example, the prediction system 126 can generate prediction data 132 associated with each of the respective one or more objects proximate to the vehicle 102. The prediction data 132 can be indicative of one or more predicted future locations of each respective object. The prediction data 132 can be indicative of a predicted path (e.g., predicted trajectory) of at least one object within the surrounding environment of the vehicle 102. For example, the predicted path (e.g., trajectory) can indicate a path along which the respective object is predicted to travel over time (and/or the velocity at which the object is predicted to travel along the predicted path). The prediction system 126 can provide the prediction data 132 associated with the one or more objects to the motion planning system 128.

The motion planning system 128 can determine a motion plan and generate motion plan data 134 for the vehicle 102 based at least in part on the prediction data 132 (and/or other data). The motion plan data 134 can include vehicle actions with respect to the objects proximate to the vehicle 102 as well as the predicted movements. For example, the motion planning system 128 can implement an optimization algorithm that considers cost data associated with a vehicle action as well as other objective functions (e.g., cost functions based on speed limits, traffic lights, and/or other aspects of the environment), if any, to determine optimized variables that make up the motion plan data 134. By way of example, the motion planning system 128 can determine that the vehicle 102 can perform a certain action (e.g., pass an object) without increasing the potential risk to the vehicle 102 and/or violating any traffic laws (e.g., speed limits, lane boundaries, signage). The motion plan data 134 can include a planned trajectory, velocity, acceleration, and/or other actions of the vehicle 102.

As one example, in some implementations, the motion planning system 128 can determine a cost function for each of one or more candidate motion plans for the autonomous vehicle 102 based at least in part on the current locations and/or predicted future locations and/or moving paths of the objects. For example, the cost function can describe a cost (e.g., over time) of adhering to a particular candidate motion plan. For example, the cost described by a cost function can increase when the autonomous vehicle 102 approaches impact with another object and/or deviates from a preferred pathway (e.g., a predetermined travel route).

Thus, given information about the current locations and/or predicted future locations and/or moving paths of objects, the motion planning system 128 can determine a cost of adhering to a particular candidate pathway. The motion planning system 128 can select or determine a motion plan for the autonomous vehicle 102 based at least in part on the cost function(s). For example, the motion plan that minimizes the cost function can be selected or otherwise determined. The motion planning system 128 then can provide the selected motion plan to a vehicle controller that controls one or more vehicle controls (e.g., actuators or other devices that control gas flow, steering, braking, etc.) to execute the selected motion plan.

The motion planning system 128 can provide the motion plan data 134 with data indicative of the vehicle actions, a planned trajectory, and/or other operating parameters to the vehicle control systems 138 to implement the motion plan data 134 for the vehicle 102. For example, the vehicle 102 can include a mobility controller configured to translate the motion plan data 134 into instructions. By way of example, the mobility controller can translate a determined motion plan data 134 into instructions for controlling the vehicle 102 including adjusting the steering of the vehicle 102 “X” degrees and/or applying a certain magnitude of braking force. The mobility controller can send one or more control signals to the responsible vehicle control component (e.g., braking control system, steering control system and/or acceleration control system) to execute the instructions and implement the motion plan data 134.

The vehicle computing system 112 can include a communications system 136 configured to allow the vehicle computing system 112 (and its one or more computing devices) to communicate with other computing devices. The vehicle computing system 112 can use the communications system 136 to communicate with the service entity computing system 104, the third-party entity computing system 106, and/or one or more other remote computing devices over one or more networks (e.g., via one or more wireless signal connections, etc.). In some implementations, the communications system 136 can allow communication among one or more of the system on-board the vehicle 102. The communications system 136 can also be configured to enable the autonomous vehicle to communicate with and/or provide and/or receive data and/or signals from a remote computing device associated with a user and/or an item (e.g., an item to be picked-up for a courier service). The communications system 136 can utilize various communication technologies including, for example, radio frequency signaling and/or Bluetooth low energy protocol. The communications system 136 can include any suitable components for interfacing with one or more networks, including, for example, one or more: transmitters, receivers, ports, controllers, antennas, and/or other suitable components that can help facilitate communication. In some implementations, the communications system 136 can include a plurality of components (e.g., antennas, transmitters, and/or receivers) that allow it to implement and utilize multiple-input, multiple-output (MIMO) technology and communication techniques.

The vehicle computing system 112 can include the one or more human-machine interfaces 140. For example, the vehicle computing system 112 can include one or more display devices located on the vehicle computing system 112. A display device (e.g., screen of a tablet, laptop, and/or smartphone) can be viewable by a user of the vehicle 102 that is located in the front of the vehicle 102 (e.g., driver's seat, front passenger seat). Additionally, or alternatively, a display device can be viewable by a user of the vehicle 102 that is located in the rear of the vehicle 102 (e.g., a back passenger seat).

FIG. 2 depicts an example communication system 200 according to example aspects of the present disclosure. As depicted, a communication system 200 can include a service entity computing system 210 and one or more third-party entity computing systems 230 and 250. Service entity computing system 220 can correspond to a service entity computing system 104, and third-party entity computing systems 230 and 250 can each correspond to a third-party entity computing system 106, depicted in FIG. 1. As shown in FIG. 2, two third-party computing systems 230 and 250 can communicate with the service entity computing system 210. The service entity computing system 210 can be associated with a service entity (e.g., service provider) which provides one or more vehicle services to the third-party entities. Each third-party entity can have one or more autonomous vehicles associated with the third-party entity (e.g., autonomous vehicle fleets 240A-C and 260A-C). As an example, the service entity can provide vehicle services (e.g., trip offers, supply positioning services, etc.) to third-party autonomous vehicles 240A-C and 260A-C associated with third-party entities.

As described herein, a service entity computing system 210 can include a Public Vehicle Integration Platform (VIP) 220 to facilitate vehicle services (e.g., provided via one or more system clients (212A, 212B) associated with a service entity computing system 210) between the service entity computing system 210 (e.g., operations computing system, etc.) and autonomous vehicles associated with one or more third-party entities (240A-C, 260A-C), etc.). For example, in some implementations, the Public VIP 220 can provide access to service entity services (e.g., associated with the service entity computing system 210) such as trip assignment services, routing services, supply positioning services, payment services, and/or the like.

The Public VIP 220 can include a one or more APIs 222 to facilitate communication from the autonomous vehicles 240A-C and 260A-C to the service entity services (e.g., system clients 212A, 212B, etc.).

In some implementations, the Public VIP 220 can be a logical construct that contains all vehicle and/or service facing interfaces. The Public VIP 220 can include a plurality of backend services interfaces (e.g., public platform backend interfaces 224). Each backend interface 224 can be associated with at least one system client (e.g., service entity computing system 210 clients such as system clients 212A and 212B). A system client (e.g., 212A, 212B, etc.) can be the hardware and/or software implemented on a computing system (e.g., the service entity computing system 210) that is remote from an autonomous vehicle and that provides a particular back-end service to the autonomous vehicle (e.g., scheduling of vehicle service assignments, routing services, payment services, user services, etc.). A backend interface 224 can be the interface (e.g., a normalized interface) that allows one application and/or system (e.g., of the autonomous vehicle) to provide data to and/or obtain data from another application and/or system (e.g., a system client). Each backend interface 224 can have one or more functions that are associated with the particular backend interface 224.

In some implementations, the Public VIP 220 can include one or more adapters 226, for example, to provide compatibility between one or more backend interfaces 224 and one or more service entity system clients (e.g., 212A, 212B, etc.). In some implementations, the adapter(s) 226 can provide upstream and/or downstream separation between the service entity computing system 210 (e.g., system clients 212A, 212B, etc.) and the Public VIP 220 (e.g., backend interfaces 224, etc.). In some implementations, the adapter(s) 226 can provide or assist with data curation from upstream services (e.g., system clients), flow normalization and/or consolidation, extensity, and/or the like.

The Public VIP 220 can also include one or more vehicle identifiers (VIDs) 228. The VIDs 228 can be, for example, unique VIDs associated with each particular autonomous vehicle 240A-C and 260A-C. In some implementations, the VIDs 228 can be stored in a stand-alone library. In some implementations, the VIDs 228 can be a component of a larger library. In some implementations, the VIDs 228 can be generated by the Public VIP 220, such as when a request to register a new third-party autonomous vehicle is received.

Each third-party entity computing system 230 and 250 can correspond to a separate third-party entity. For example, a third-party entity computing system 230 can be a computing system associated with an OEM, and third-party entity computing system 250 can be associated with a vendor or an autonomous vehicle fleet owner.

The third-party entity computing systems 230 and 250 can include one or more computing devices that are remote from the autonomous vehicles 240A-C and 260A-C (e.g., located off-board the autonomous vehicles 240A-C and 260A-C). For example, such computing device(s) can be components of a cloud-based server system and/or other type of computing system that can communicate with the vehicle computing systems (e.g., vehicle computing systems 112) of the autonomous vehicles 240A-C and 260A-C, a service entity computing system 210, and/or other computing systems (e.g., user computing systems, etc.) The third-party entity computing systems 230 and 250 can be or otherwise included in a data center for the third-party, for example. The third-party entity computing systems 230 and 250 can be distributed across one or more location(s) and include one or more sub-systems. The computing device(s) of the third-party entity computing systems 230 and 250 can include various components for performing various operations and functions. For example, the computing device(s) can include one or more processor(s) and one or more tangible, non-transitory, computer readable media (e.g., memory devices, etc.). The one or more tangible, non-transitory, computer readable media can store instructions that when executed by the one or more processor(s) cause the third-party entity computing systems 230 and 250 (e.g., the one or more processors, etc.) to perform operations and functions, such as communicating data to and/or obtaining data from the autonomous vehicles 240A-C and 260A-C, and communicating data to and/or obtaining data from the service entity computing system 210.

For example, according to example aspects of the present disclosure, the third-party entity computing systems 230 and 250 can include one or more cloud-based software development kits (SDKs) (e.g., set of tools and core libraries), such as Cloud SDKs 234A-B and 254A-B, that provide access to the Public VIP 220 for use of third-party entity autonomous vehicles 240A-C and 260A-C. The Cloud SDKs 234A-B and 254A-B can be software package(s) integrated into a third-party entity's backend 232 and 254 of the third-party entity computing systems 230 and 250, respectively. In some implementations, a Cloud SDK 234A-B and 254A-B can be tailored to an individual third-party entity. For example, each Cloud SDK 234A-B and 254A-B can be provided to a third-party entity by the service entity as one or more libraries with one or more exposed application programming interfaces (APIs). The third-party entity can then integrate the Cloud SDKs 234A-B and 254A-B into the third-party entity's backend 232 and 252. For example, in some implementations, the Cloud SDKs 234A-B and 254A-B can be written in a C++ library implementation with C++, Go, and/or Java interfaces/bindings exposed to allow for easier integration into the third-party entity backends 232 and 252. Using a single source of implementation in a C++ library can help to avoid inconsistencies in how different implementations function for specific third-party entities.

In some implementations, all external communication with the Public VIP 220 can be done via the Cloud SDKs 234A-B and 254A-B. For example, the communication system 200 can include the Cloud SDKs 234A-B and 254A-B and specific endpoints to facilitate communication with the Public VIP 220. In some implementations, Cloud SDKs 234A-B and 254A-B can provide a single entry point into the Public VIP 220, which can improve consistency across the third-party entity fleet(s). As an example, Cloud SDKs 234A-B and 254A-B can provide secured access to the Public VIP 220 by the third-party entity (and/or third-party autonomous vehicles 240A-C and 260A-C) and access to capabilities such as trip assignment, routing, onboarding new vehicles, supply positioning, monitoring and statistics, a platform sandbox (e.g., for integration and testing), and/or the like.

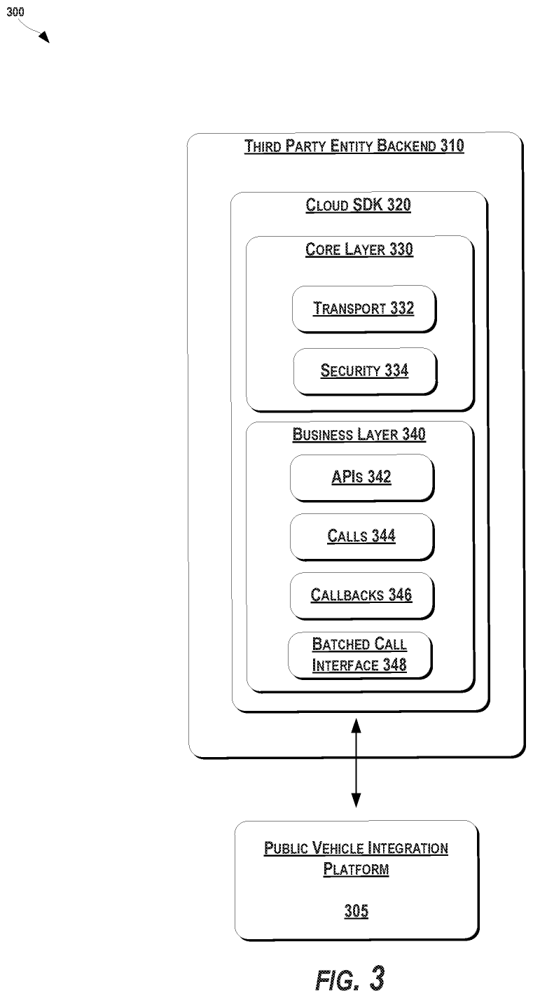

In some implementations, each autonomous vehicle 240A-C and 260A-C can have a corresponding instantiation of a Cloud SDK in a third-party entity backend (e.g., Cloud SDK 234B for autonomous vehicle 240C). In other implementations, a Cloud SDK can facilitate communication for a plurality of autonomous vehicles (e.g., Cloud SDK 234A for autonomous vehicles 240A and 240B). In implementations in which a Cloud SDK 234A-B and 254A-B facilitates communication for a plurality of autonomous vehicles 240A-C and 260A-C, the Public VIP 220 can include a VID 228 in communications (e.g., calls) with the Cloud SDK 234A-B and 254A-B to identify a particular autonomous vehicle 240A-C and 260A-C. Further, as will be described in greater detail with respect to FIG. 3, the Cloud SDK 234A-B and 254A-B can authenticate messages (e.g., callbacks) on behalf of particular autonomous vehicles 240A-C and 260A-C, such as by signing messages on behalf of the autonomous vehicles 240A-C and 260A-C.

In some implementations, the Cloud SDKs 234A-B and 254A-B can include a command-line interface to provide an entry point into the Cloud SDK components and act as a gateway for SDK related work, integration, testing, and authentication. For example, the command-line tools can provide for bootstrapping, managing authentication, updating SDK version, testing, debugging, and/or the like. In some implementations, a command-line interface can require an authentication certificate before being able to bootstrap a Cloud SDK, download components, and/or access a service entity's services. For example, based on the authentication certificate, a command-line interface can determine which services of a service entity to provide a third-party entity access to.

An autonomous vehicle 240A-C and 260A-C can provide a communication to the Public VIP 220 via the Cloud SDKs 234A-B and 254A-B to call a function of a backend interface 224. In this way, the backend interfaces 224 can be an external facing edge of the service entity computing system 210 that is responsible for providing a secure tunnel for a vehicle and/or other system to communicate with a particular service entity system client (e.g., 212A, 212B, etc.) so that the vehicle and/or other system can utilize the backend service associated with that particular service entity system client (e.g., 212A, 212B, etc.), and vice versa.

An advantage provided by utilizing the Cloud SDKs 234A-B and 254A-B to facilitate communication between the third-party autonomous vehicles 240A-C and 260A-C and the service entity computing system 210 is the ability to isolate the software operating on any particular autonomous vehicle 240A-C and 260A-C. For example, an OEM can use the Cloud SDKs 234A-B and 254A-B to access service entity services, while maintaining control (e.g., version/source control) over all software operating on the OEM's autonomous vehicles.

FIG. 3 depicts a block diagram of an example communication system 300 according to example aspects of the present disclosure. As shown, a communication system 300 can include a third-party entity backend 310 and a Public VIP 305. The third-party entity backend 310 can correspond to a third-party entity backend 232 and/or 252, and a Public VIP 305 can correspond to a Public VIP 220, as depicted in FIG. 2.

As shown, the Cloud SDK 320 can include a core layer 330 and a business layer 340. According to example aspects of the present disclosure, the core layer 330 can be configured to address transport logic 332 and security logic 334. For example, the core layer 330 can include transport logic 332 which can be configured to manage the connection between the cloud SDK 320 and the Public VIP 305. As an example, the transport logic 332 can establish and maintain a connection between the cloud SDK 320 and the Public VIP 305. In some implementations, the core layer 330, and more particularly, the transport logic 332, can be essentially uniform across multiple versions of the cloud SDK 320. For example, the transport logic 332 can be essentially standardized such that the connection protocol between the Public VIP 305 and the cloud SDK 320 remains the same for various third-party entities. This can allow for standardized communication connections to be established between various third-party entities and a Public VIP 305 of a service entity.

The security logic 334 can be configured to provide security for communications between the cloud SDK 320 and the Public VIP 305. For example, the security logic 334 can implement various encryption techniques to encrypt messages sent to the Public VIP 305.

In some implementations, the security logic 334 can act as a security delegate for one or more third-party autonomous vehicles. As an example, in some implementations, the Cloud SDK can receive messages signed by individual third-party autonomous vehicles, and communicate the signed messages to the Public VIP 305. In other implementations, the Cloud SDK can sign messages sent to the Public VIP 305 on behalf of a third-party autonomous vehicle.

For example, the security logic 334 can obtain a security handle for a particular autonomous vehicle. In some implementations, the security logic 334 can obtain a security certificate for a particular autonomous vehicle, such as by requesting a security certificate from a registration authority (RA) system. For example, a RA system can be configured to implement onboarding/provisioning of new third-party autonomous vehicles as well as certificate-based licensing. In some implementations, the RA system can be implemented as a part of a service entity's Public VIP 305, while in other implementations, the RA system can be a stand-alone system. In accordance with onboarding/provisioning, a RA system can be configured to generate a license to operate certificate for each third-party autonomous vehicle that establishes a client-specific identity credential from a plurality of possible identity credentials. For example, in some implementations, a third-party entity can generate a provisioning process request and provide this request to the RA system to initiate provisioning via the Cloud SDK 320. In other implementations, a third-party autonomous vehicle can generate a message that is provided to the Public VIP 305 via the Cloud SDK 320 (such as when a new third-party autonomous vehicle is added to a third-party entity's fleet), and upon receipt, the Public VIP 305 can provide the provisioning process request to the RA. In some implementations, the client-specific identity credential can include information configured to provide client-specific identification as well as information configured to provide vendor-specific identification. The generation and provision of a license to operate certificate by an RA system to a client (e.g., a third-party entity or third-party autonomous vehicle) can enable subsequent operational certificates to be created. In some implementations, the credentials generated by the RA system(s) in the form of operational licenses can be short-lived certificates that, in some implementations, must be re-requested periodically. In some implementations, the operational certificates can sometimes contain embedded metadata such as a VID generated by the service entity. In some implementations, the credentials generated by the RA can be a requirement for message acceptance by the Public VIP 305. In some implementations, the client-specific credentials can be configured to expire after the predetermined time period such that each client must request renewed credentials from the RA system.

In some implementations, the RA systems can be communicatively coupled with a certificate authority (CA) system. In some implementations, the CA system can be implemented as a part of a service entity's Public VIP 305, while in others, the CA system can be a stand-alone system. In general, the CA system can be configured to normalize requests received from the clients (e.g., third-party entities, third-party autonomous vehicles) via the one or more RA systems such that the client-specific credentials are established according to an approved hierarchy of licensing certificates. More particularly, the CA system can provide a discrete root CA for all clients. Per-vendor (e.g., third-party entity) intermediate CA systems can be considered as children of the CA system in a hierarchy of licensing certificates. Additional entities within an example approved hierarchy of licensing certificates can include service provider certificates, client certificates, vendor certificates, vehicle certificates, session certificates, etc. This example hierarchy follows the natural taxonomy of autonomous vehicles. It allows for both cryptographically tracing ownership toward the top of the hierarchy (e.g., “which vendor/entity does this vehicle belong to”) as well as flexibly granular revocation of credentials. The RA and CA systems can thus work together to provide signed certificates to a client, which can be provided to a Cloud SDK 320 upon request. Once obtained, the Cloud SDK 320 can sign messages sent on behalf of a particular third-party autonomous vehicle.

The business layer 340 of a Cloud SDK 320 can be configured to interface with a third-party entity's backend 310. For example, the business layer 340 can include one or more exposed APIs 342, which can be tailored and/or adapted to integrate into a particular third-party entity's backend 310.

In some implementations, the business layer 340 can include different components to serve the particular preferences of a particular third-party entity. For example, the business layer 340 can include logic to receive one or more calls 344 or provide one or more callbacks 346. For example, the one or more calls 344 can include one or more actions for an autonomous vehicle to perform. As an example, the Public VIP 305 can send one or more calls 344 to the cloud SDK 320, which can include one or more actions or instructions for a particular autonomous vehicle to perform. In response to a call 344 and/or independent of receiving a call 344, the autonomous vehicle can send one or more callbacks 346 to the Cloud SDK 320. The calls 344 and/or callbacks 346 can be associated with the provision of one or more backend services facilitated by the service entity, and a Cloud SDK 320 for a particular third-party entity can be tailored to receive calls 344 and provide callbacks 346 associated with the backend services requested by the third-party entity.

For example, in some implementations, a call can include instructions for a vehicle to come online or go offline. For example, a third-party entity may request a service entity to manage the third-party entity's fleet of autonomous vehicles, such as managing the state of the third-party's fleet of vehicles. The service entity can send a call 344 from the Public VIP 305 to the cloud SDK 320, which can include instructions for an autonomous vehicle to come online or go offline. In some implementations, the third-party entity and/or the third-party autonomous vehicle can manage the state of the third-party autonomous vehicle, and can send a callback 346 including a notification that the third-party autonomous vehicle is coming online or going offline. For example, the third-party autonomous vehicle can come online to perform trips (e.g., perform vehicle services) and/or for supply positioning (e.g., relocating to an area for anticipated demand).

In some implementations, the one or more calls 344 can include a trip offer. For example, the trip offer can be an offer for a particular third-party autonomous vehicle to perform one or more vehicle services, such as transporting a passenger or delivering an item. In response, the third-party autonomous vehicle can send a callback 346 accepting the trip offer or rejecting the trip offer. The cloud SDK 320 can receive the callback 346, and communicate the callback 346 to the Public VIP 305 on behalf of the third-party autonomous vehicle.

In some implementations, the one or more calls 344 can include a request for the at least one particular autonomous vehicle's location. In response, the third-party autonomous vehicle can provide a callback 346 which includes the third-party autonomous vehicle's location. In some implementations, the third-party autonomous vehicle can be configured to provide routine location updates, such as at a regular interval (e.g., every 4 seconds). The location updates can be sent by the third-party autonomous vehicle to the cloud SDK, which can then provide the location update as a callback 346 to the Public VIP 305.

In some implementations, the one or more calls 344 can include instructions to begin a trip, instructions to finish a trip, instructions to perform a stop, instructions to cancel a trip, instructions to position the autonomous vehicle at a particular location (e.g., for supply positioning), or one or more utility commands (e.g., open/close the trunk, lock/unlock a door, and/or open/close a door, etc.). For example, a third-party autonomous vehicle can accept a trip via a callback 346, and the service entity can send a subsequent call 344 to begin the trip. Similarly, after accepting the trip, the third-party autonomous vehicle may encounter an obstacle which prevents the third-party autonomous vehicle from completing the trip. In such a situation, the third-party autonomous vehicle can send a callback 346 canceling the trip. In some implementations, the third-party autonomous vehicle may provide periodic updates via one or more callbacks 346 while the third-party autonomous vehicle is performing a trip. As an example, the third-party autonomous vehicle can send a callback 346 which can include a notification of a completion of a task at a waypoint. Similarly, the third-party autonomous vehicle may provide periodic location updates as one or more callbacks 346. In this way, the calls 344 and/or the callbacks 346 which can be received or sent, respectively, by the Cloud SDK 320 can be tailored to a particular third-party entity based on the vehicle services the third-party entity performs and/or the backend services requested by the third-party entity.

As noted herein, in some implementations, a Cloud SDK 320 can enable communication between a plurality of third-party autonomous vehicles and a Public VIP 305. In such an implementation, the Public VIP 305 can include one or more VIDs in calls 344 sent to the cloud SDK 320. For example, the one or more VIDs can identify to which particular vehicle(s) the call(s) 344 are directed.

As an example, in some implementations, a service entity can send a batched call 344 to a plurality of third-party autonomous vehicles (e.g., a fleet of third-party autonomous vehicles or a subset thereof) to bring the plurality of third-party autonomous vehicles online for trips or supply positioning. In some implementations, the batched call 344 can include a VID for each of the plurality of third-party autonomous vehicles to come online. In some implementations, the VID can be a fleet VID which identifies each third-party autonomous vehicle in the third-party entity's fleet.

In some implementations, a batched call interface 348 of a business layer 340 can be used to direct the batched call 344 to the plurality of third-party autonomous vehicles identified in the batched call 344. For example, the batched call interface 348 can send individual communications to each of the third-party autonomous vehicles identified in the batched call 344.

In some implementations, the batched call interface 348 can also be configured to batch a plurality of callbacks 346. For example, in some implementations, each third-party autonomous vehicle in a fleet may provide one or more periodic location updates as callbacks 346. Rather than sending a corresponding callback 346 for each third-party autonomous vehicle, the batched call interface 348 can combine the plurality of callbacks 346 into a single communication (e.g., a batched callback 346). For example, the batched call interface 348 can combine the plurality of callbacks 346 along with a respective VID and/or respective signature (e.g., a security certificate) on behalf of the plurality of third-party autonomous vehicles. In this way, the batched call interface 348 can send and receive batched calls for a plurality of third-party autonomous vehicles.

In some implementations, the cloud SDK 320 can be configured to determine whether an open communication connection associated with a service entity and an autonomous vehicle is established. For example, a third-party autonomous vehicle may send a callback on behalf of a particular third-party autonomous vehicle to the Public VIP 305. In order to do so, the cloud SDK 320 can establish a communication connection, such as via a core layer 330 of the cloud SDK. A subsequent call 344 from the Public VIP 305 to the third-party autonomous vehicle or a subsequent callback 346 from the third-party autonomous vehicle to the public integration platform 305 can be received by the cloud SDK 320, and if the open communication connection is still established (e.g., has not been closed, such as due to a timeout), the cloud SDK 320 can send the subsequent call 344 or subsequent callback 346 via the open communication connection. If, however, no such open communication connection is established (e.g., such as for a first call 344 or callback 346 or if a previously open communication connection has been disconnected), the cloud SDK 320 can establish a new communication connection, such as via the core layer 330, and communicate the call 344 or callback 346 via the new communication connection.

In some implementations, multiple instantiations of a cloud SDK 320 may be operating on a third-party entity's backend 310. For example, in a cloud-based architecture, a plurality of connected computing devices may each have an instantiation of a cloud SDK 320 operating thereon. In such an implementation, when the Public VIP 305 sends a call 344 to a particular third-party autonomous vehicle, a previously-established communication connection may exist between a particular instantiation of a cloud SDK 320 and the particular third-party autonomous vehicle. In some implementations, the Public VIP 305 can push the call 344 to each instantiation of the Cloud SDK 320, and the instantiation of the Cloud SDK 320 which has the previously-established communication connection with the particular third-party autonomous vehicle can send the call 344 to the particular third-party autonomous vehicle via the previously-established communication connection. In some implementations, the Public VIP 305 can send the call 344 to any of the instantiations of the Cloud SDK 320, which can provide the call 344 to the third-party entity's backend 310. The third-party entity's backend 310 can then provide the call 344 to the instantiation of the Cloud SDK 320 with the previously-established communication connection, which can send the call 344 to the particular third-party autonomous vehicle via the previously-established communication connection.

The Cloud SDK 320 described herein can include computer logic utilized to provide desired functionality. For example, in some implementations, the Cloud SDK 320 includes program files stored on a storage device, loaded into a memory and executed by one or more processors. In other implementations, the Cloud SDK 320 includes one or more sets of computer-executable instructions that are stored in a tangible computer-readable storage medium such as RAM hard disk or optical or magnetic media.

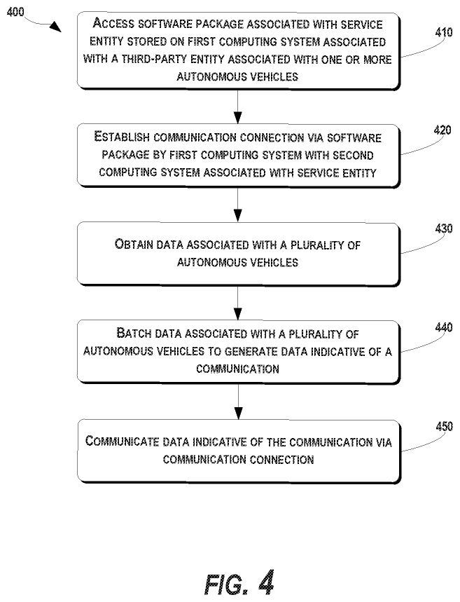

FIG. 4 depicts a flow diagram of an example method 400 for communication between a service entity and a third-party entity according to example aspects of the present disclosure. One or more portion(s) of the method 400 can be implemented by a communication system that includes one or more computing devices such as, for example, the computing systems described with reference to the other figures (e.g., a service entity computing system, a third-party entity computing system, an autonomous vehicle computing system, etc.). Each respective portion of the method 400 can be performed by any (or any combination) of one or more computing devices. FIG. 4 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 4 is described with reference to elements/terms described with respect to other systems and figures for example illustrated purposes and is not meant to be limiting. One or more portions of method 400 can be performed additionally, or alternatively, by other systems.

At 410, the method 400 can include accessing a software package stored within a first computing system. The first computing system can be associated with a third-party entity, such as a vendor or an OEM. For example, the software package can be a Cloud SDK, which can be integrated into a backend of the third-party entity's computing system. The third-party entity can be associated with one or more autonomous vehicles, such as a fleet. The software package can be associated with a service entity that coordinates a vehicle service for the one or more autonomous vehicles. For example, the service entity can provide one or more backend services to help facilitate the vehicle service.

At 420, the method 400 can include establishing a communication connection with a second computing system that is associated with the service entity via the software package. For example, the second computing system can include a Public VIP. The software package can establish the communication connection between the backend of the third-party entity's computing system and the Public VIP.

In some implementations, the software package can established the communication connection via a core layer of the software package. For example, the core layer can be configured to provide transport logic and/or security logic for the communication connection.

At 430, the method 400 can include obtaining data associated with a plurality of autonomous vehicles. For example, in some implementations, a plurality of autonomous vehicles can each communicate a respective callback to the software package, such as a periodic location update. Similarly, in some implementations, a Public VIP can determine a plurality of calls (e.g., actions, trip offers, etc.) for a plurality of third-party autonomous vehicles.

At 440, the method 400 can include batching the data associated with a plurality of autonomous vehicles to generate data indicative of a communication. For example, the plurality of callbacks, such as the plurality of periodic location updates, can be combined into a single communication. Similarly, the plurality of calls (e.g., actions, trip offers, etc.) can be combined into a single communication. In some implementations, in order to identify a particular third-party autonomous vehicle to which a call is directed or from which a callback is received, the batched call can include a plurality of VIDs.

At 450, the method 400 can include communicating data indicative of a communication associated with the one or more vehicles via the communication connection. For example, the data indicative of a communication can be communicated in both an upstream direction (e.g., from one or more third-party autonomous vehicles to a Public VIP) and a downstream direction (e.g., from the Public VIP to the one or more third-party autonomous vehicles).

In some implementations, the data indicative of the communication can include data associated with a VID for at least one third-party autonomous vehicle. For example, the VID can be a unique identifier associated with a particular autonomous vehicle.

In some implementations, the data indicative of the communication can include data associated with registration of one or more autonomous vehicles. For example, the data indicative of the communication can include a request to register one or more third-party autonomous vehicles with the service entity.

In some implementations, the data indicative of the communication can include data associated with a security certificate of the one or more autonomous vehicles. For example, in some implementations, the data indicative of the communication can include a request to a registration authority (RA) system to issue a license to operate certificate for a third-party autonomous vehicle. In some implementations, the data indicative of the communication can include the operational certificate, such as from the RA system to the Cloud SDK.

In some implementations, the software package can be configured to act as a security delegate for the one or more autonomous vehicles. For example, in some implementations, a third-party autonomous vehicle can sign a message (e.g., a callback) and provide the signed message to the cloud SDK. In some implementations, the cloud SDK can be configured to sign the message (e.g., the callback) on behalf of the third-party autonomous vehicle.

In some implementations, the data indicative of the communication can include data associated with at least one of one or more vehicle states, one or more calls, or one or more callbacks. For example, the one or more states can include an online state or an offline state, such as whether an autonomous vehicle is online for trips and/or supply positioning, or offline for trips and/or supply positioning. The one or more calls can include one or more actions for the one or more autonomous vehicles to perform. For example, the one or more calls can include instructions for an autonomous vehicle to go offline, the instructions for an autonomous vehicle to come online, a trip offer, a request for the location of an autonomous vehicle, instructions to begin a trip, instructions to finish a trip, instructions to perform a stop, instructions to cancel a trip, instructions to position the autonomous vehicle at a particular location, and/or one or more utility commands. The one or more callbacks can include, for example, a notification that an autonomous vehicle is coming online for trips and/or supply positioning, a notification that an autonomous vehicle is going offline for trips and/or supply positioning, a trip cancellation, an acceptance or a rejection of a trip offer, a location of the autonomous vehicle, and/or a notification of a completion of a task at a waypoint.

In some implementations, communicating the data indicative of a communication associated with the one or more autonomous vehicles via the communication connection can include communicating the data indicative of the communication via the business layer of the software package. For example, the business layer can be configured with one or more previously-exposed APIs to allow for integration into the third-party entity's backend.

In some implementations, prior to communicating the data indicative of the communication associated with the one or more autonomous vehicles, the method can include receiving the data indicative of the communication from the one or more autonomous vehicles. For example, for upstream communications, the Cloud SDK can first receive the data indicative of the communication from an autonomous vehicle, and once a communication connection has been established, communicate the data indicative of the communication from the Cloud SDK to the Public VIP.

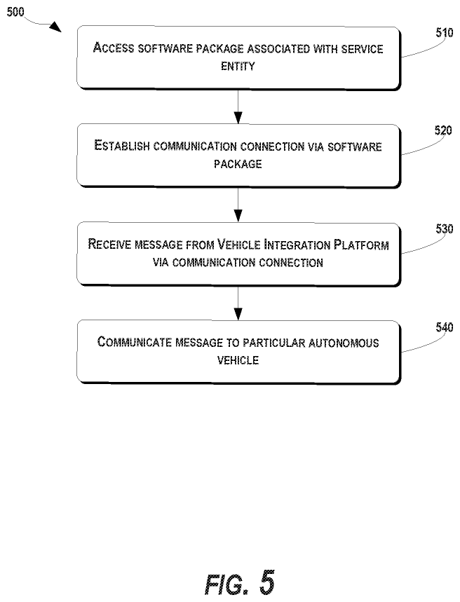

FIG. 5 depicts a flow diagram of an example method 500 for communication from a service entity to a third-party autonomous vehicle according to example aspects of the present disclosure. One or more portion(s) of the method 500 can be implemented by a communication system that includes one or more computing devices such as, for example, the computing systems described with reference to the other figures (e.g., a service entity computing system, a third-party entity computing system, an autonomous vehicle computing system, etc.). Each respective portion of the method 500 can be performed by any (or any combination) of one or more computing devices. FIG. 5 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 5 is described with reference to elements/terms described with respect to other systems and figures for example illustrated purposes and is not meant to be limiting. One or more portions of method 500 can be performed additionally, or alternatively, by other systems.

At 510, the method 500 can include accessing a software package associated with a service entity. For example, a third-party entity computing system can have or otherwise include the software package associated with the service entity. For example, the software package can be a cloud SDK and can be stored on one or more memory devices of the third-party entity computing system. In some implementations, the software package can include one or more libraries with one or more previously-exposed application programming interfaces which have been integrated into the backend of the third-party entity computing system.

At 520, the method 500 can include establishing a communication connection between the third-party entity computing system and a service entity computing system via the software package. For example, the second computing system can include a Public VIP comprising a plurality of application programming interfaces. Each of the plurality of application programming interfaces can be configured to provide one or more backend services to help facilitate one or more vehicle services. The third-party entity computing system can establish the communication connection via the software package, such as via a core layer of the software package.

At 530, the method 500 can include receiving a message from the Public VIP via the communication connection. For example, in some implementations, the message can include at least one VID associated with at least one particular autonomous vehicle associated with the third-party entity. For example, the at least one VID can be a unique identifier associated with the at least one particular autonomous vehicle in the third-party entity's fleet.

In some implementations, the message can include a call to the at least one particular autonomous vehicle. For example, the call can include one or more of: instructions for the at least one particular autonomous vehicle to come online, instructions for the at least one particular autonomous vehicle to go offline, a trip offer, a request for the at least one particular autonomous vehicle's location, instructions to begin a trip, instructions to finish a trip, instructions to perform a stop, instructions to cancel a trip, instructions to position the at least one particular autonomous vehicle at a particular location, and/or one or more utility commands.

At 540, the method 500 can include communicating the message to the at least one particular autonomous vehicle. For example, the software package (e.g., Cloud SDK) can communicate the message to the at least one particular autonomous vehicle over a communication network.

In some implementations, the message can be a batched message comprising a plurality of messages for a plurality of autonomous vehicles associated with the third-party entity. Each message in the plurality can include a respective VID that is associated with a respective particular autonomous vehicle of the plurality of autonomous vehicles. For example, a Public VIP can batch a plurality of messages, each with a unique VID, which can identify the autonomous vehicle in the third-party fleet to which each message is directed.

Further, in some implementations, communicating the message to the at least one particular autonomous vehicle can include communicating each respective message in the plurality of messages to the respective particular autonomous vehicle associated with the respective VID in the respective message. For example, the software package can communicate each respective message to the autonomous vehicle in the third-party fleet to which the message is directed.

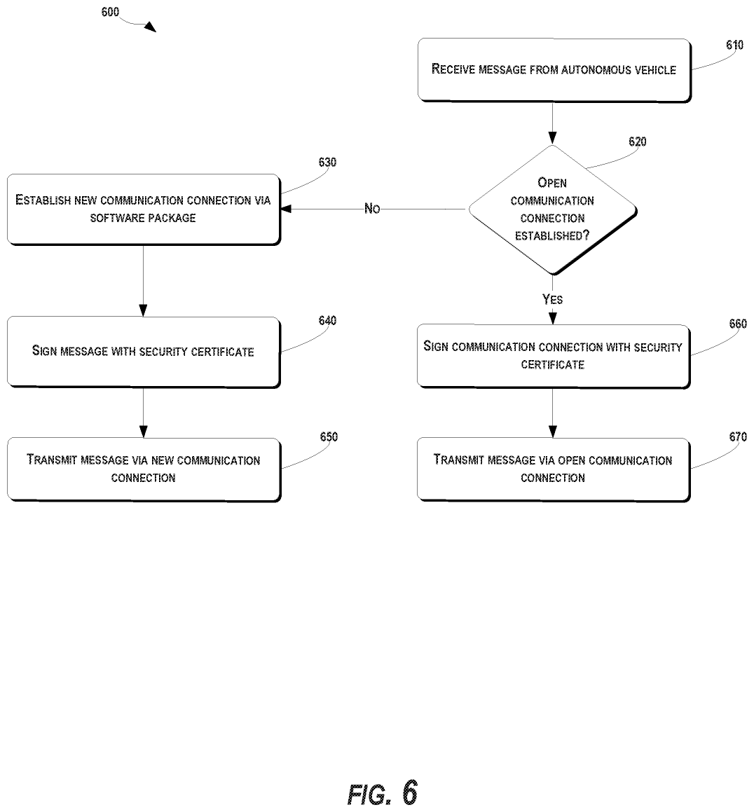

FIG. 6 depicts a flow diagram of an example method 600 for communication from a third-party autonomous vehicle to a service entity according to example aspects of the present disclosure. One or more portion(s) of the method 600 can be implemented by a communication system that includes one or more computing devices such as, for example, the computing systems described with reference to the other figures (e.g., a service entity computing system, a third-party entity computing system, an autonomous vehicle computing system, etc.). Each respective portion of the method 600 can be performed by any (or any combination) of one or more computing devices. FIG. 6 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 6 is described with reference to elements/terms described with respect to other systems and figures for example illustrated purposes and is not meant to be limiting. One or more portions of method 600 can be performed additionally, or alternatively, by other systems.

At 610, the method 600 can include receiving a message from an autonomous vehicle associated with a third-party entity. For example, a cloud-based software package (e.g., a Cloud SDK) can be integrated into a third-party entity's backend. An autonomous vehicle associated with the third-party entity, such as an autonomous vehicle in the third-party entity's fleet, can send a message to the third-party entity's computing system, such as over a communication network.

In some implementations, the message can include one or more callbacks from the autonomous vehicle to the service entity. For example, the one or more callbacks can include one or more of: a notification that the autonomous vehicle is coming online for trips or supply positioning, a notification that the autonomous vehicle is going offline for trips or supply positioning, a trip cancellation, an acceptance or a rejection of a trip offer, a location of the autonomous vehicle, and/or a notification of a completion of a task at a waypoint.

At 620, the method 600 can include determining whether an open communication connection associated with the service entity and the autonomous vehicle is established. For example, in some implementations, a previously-established service connection can exist, such as when the autonomous vehicle previously provided one or more callbacks to the service entity or when the service entity (e.g., a Public VIP) sent one or more calls to the third-party entity's backend. In some implementations, the communication connection can be maintained for a period of time to allow for subsequent communications to be sent.

If at 620 an open communication connection is not established, at 630, the method 600 can include establishing, via the software package, a new communication connection associated with the service entity and the autonomous vehicle. For example, a core layer of the software package can establish a new connection between the third-party entity's backend and the service entity, such as a Public VIP associated with the service entity.

At 640, the method 600 can include signing the message with a security certificate on behalf of the autonomous vehicle. For example, the software package can be configured to act as a security delegate for the autonomous vehicle. The software package can then sign the message on behalf of the autonomous vehicle with the security certificate.

At 650, the method 600 can include transmitting the message via the new communication connection to the service entity. For example, in some implementations, the message can be transmitted to the service entity via a business layer of the software package. In some implementations, transmitting the message to the service entity via the new communication connection can include transmitting the message to a Public VIP associated with the service entity.

If, however, at 620, an open communication connection has been established, at 660, the method 600 can include signing the message with a security certificate on behalf of the autonomous vehicle. For example, as with 640, the software package can be configured to act as a security delegate for the autonomous vehicle. The software package can then sign the message on behalf of the autonomous vehicle with security certificate.

At 670, the method 600 can include transmitting the message via the open communication connection to the service entity. For example, as with 650, in some implementations, the message can be transmitted to the service entity via a business layer of the software package. In some implementations, transmitting the message to the service entity via the open communication connection can include transmitting the message to a Public VIP associated with the service entity.

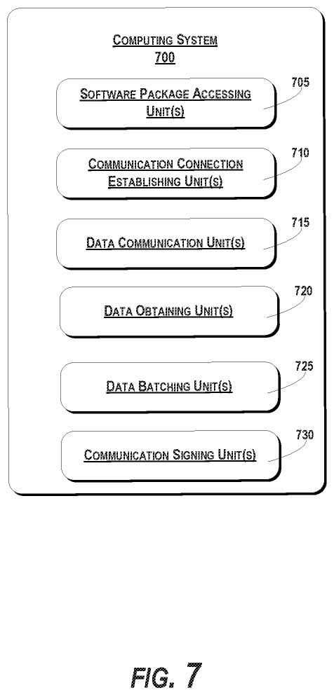

Various means can be configured to perform the methods and processes described herein. For example, FIG. 7 depicts a diagram of an example a computing system 700 that includes various means according to example aspects of the present disclosure. The computing system 700 can be and/or otherwise include, for example, the vehicle computing system 112, the service entity computing systems 104, 210, the third-party entity computing systems 106, 230, and 250, etc. The computing system 700 can include data obtaining unit(s) 705, communication connection establishing unit(s) 710, data communication unit(s) 715, data obtaining unit(s) 720, data batching unit(s) 725, communication signing unit(s) 730, and/or other means for performing the operations and functions described herein. In some implementations, one or more of the units may be implemented separately. In some implementations, one or more units may be a part of or included in one or more other units.

These means can include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The means can also, or alternately, include software control means implemented with a processor or logic circuitry for example. The means can include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware. Certain means can include other types of devices.

The means can be programmed to perform one or more algorithm(s) for carrying out the operations and functions described herein. For example, the means can be programmed to perform one or more algorithm(s) for carrying out the operations and functions for communication between a service entity and a third-party entity and/or a third-party autonomous vehicle described herein. For example, the means (e.g., the software package accessing unit(s) 705) can be configured to access a software package, such as a Cloud SDK.

The means, (e.g., the communication connection establishing unit(s) 710) can be configured to establish a communication connection between a service entity computing system and a third-party entity computing system. For example, the means (e.g., the communication connection establishing unit(s) 710) can establish a communication connection via a core layer of a software package (e.g., a Cloud SDK).

The means, (e.g., the data communication unit(s) 715) can be configured to communicate data between a service entity computing system, a third-party entity computing system, and/or a vehicle computing system. For example, the means (e.g., the data communication unit(s) 715) can communicate one or more messages (e.g., calls, callbacks, etc.) via a business layer of a software package (e.g., a Cloud SDK).

The means, (e.g., the data obtaining unit(s) 720) can be configured to obtain data from a service entity computing system, a third-party entity computing system, and/or a vehicle computing system. For example, the means (e.g., the data obtaining unit(s) 720) can obtain one or more messages (e.g., calls, callbacks, etc.) via a business layer of a software package (e.g., a Cloud SDK).

The means, (e.g., the data batching unit(s) 725) can be configured to batch a plurality of messages to or from a service entity computing system, a third-party entity computing system, and/or a vehicle computing system. For example, the means (e.g., the data batching unit(s) 725) can combine a plurality of messages (e.g., calls, callbacks, etc.) and/or extract individual messages from a batched message via a software package (e.g., a Cloud SDK).

The means, (e.g., the communication signing unit(s) 730) can be configured to sign a message to or from a computing system, a third-party entity computing system, and/or a vehicle computing system. For example, the means (e.g., the message signing unit(s) 730) can sign one or more messages (e.g., calls, callbacks, etc.) with a security certificate on behalf of an autonomous vehicle via a software package (e.g., a Cloud SDK).

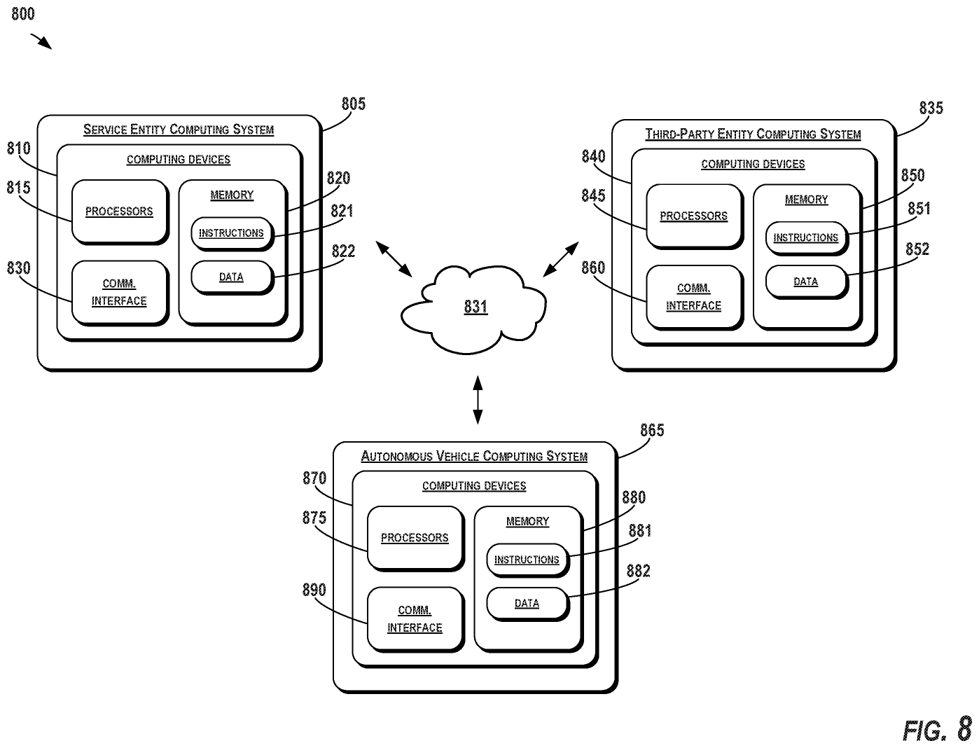

FIG. 8 depicts an example system 800 according to example aspects of the present disclosure. The example system 800 illustrated in FIG. 8 is provided as an example only. The components, systems, connections, and/or other aspects illustrated in FIG. 8 are optional and are provided as examples of what is possible, but not required, to implement the present disclosure. The example system 800 can include a service entity computing system 805 (e.g., that is associated with a service entity). The service entity computing system 805 can represent/correspond to the service entity computing systems 104 and 210 described herein. The example system 800 can include a third-party entity computing system 835 (e.g., that is associated with a third-party entity). The third-party entity computing system 835 can represent/correspond to the third-party entity computing systems 106, 230, and 250 described herein. The example system 800 can include an autonomous vehicle computing system 865 (e.g., that is onboard an autonomous vehicle). The autonomous vehicle computing system 865 can represent/correspond to the autonomous vehicle computing system 112 described herein. The service entity computing system 805, the third-party entity computing system 835, and the autonomous vehicle computing system 865 can be communicatively coupled to one another over one or more communication network(s) 831. The networks 831 can correspond to any of the networks described herein, such as communication network 108.

The computing device(s) 810 of the service entity computing system 805 can include processor(s) 815 and a memory 820. The one or more processors 815 can be any suitable processing device (e.g., a processor core, a microprocessor, an ASIC, a FPGA, a controller, a microcontroller, etc.) and can be one processor or a plurality of processors that are operatively connected. The memory 820 can include one or more non-transitory computer-readable storage media, such as RAM, ROM, EEPROM, EPROM, one or more memory devices, flash memory devices, data registrar, etc., and combinations thereof.

The memory 820 can store information that can be accessed by the one or more processors 815. For example, the memory 820 (e.g., one or more non-transitory computer-readable storage mediums, memory devices) can include computer-readable instructions 821 that can be executed by the one or more processors 815. The instructions 821 can be software written in any suitable programming language or can be implemented in hardware. Additionally, or alternatively, the instructions 821 can be executed in logically and/or virtually separate threads on processor(s) 815.

For example, the memory 820 can store instructions 821 that when executed by the one or more processors 815 cause the one or more processors 815 (the service entity computing system 805) to perform operations such as any of the operations and functions of the service entity computing system (or for which it is configured), one or more of the operations and functions for communicating between a third-party entity and/or a service entity and/or an autonomous vehicle, one or more portions of methods 400, 500, and 600, and/or one or more of the other operations and functions of the computing systems described herein.

The memory 820 can store data 822 that can be obtained (e.g., acquired, received, retrieved, accessed, created, stored, etc.). The data 822 can include, for example, data associated with communications (e.g., messages, calls, callbacks, etc.), data associated with software package(s) (e.g., Cloud SDK data), data associated with one or more backends, data associated with a Public VIP, batched data, data associated with VIDs, data associated with vehicle registration, data associated with a registration authority, data associated with a certificate authority, data associated with security certificates, data associated with autonomous vehicles, data associated with third-party entities, sensor data, map data, vehicle state data, vehicle location data, perception data, prediction data, motion planning data, data associated with a vehicle client, data associated with a communication network, data associated with an API, data associated with a library, data associated with user interfaces, data associated with user input, and/or other data/information such as, for example, that described herein. In some implementations, the computing device(s) 810 can obtain data from one or more memories that are remote from the service entity computing system 805.

The computing device(s) 810 can also include a communication interface 830 used to communicate with one or more other system(s) on-board an autonomous vehicle and/or remote from the service entity computing system, such as third-party entity computing system 835 and an autonomous vehicle computing system 865. The communication interface 830 can include any circuits, components, software, etc. for communicating via one or more networks (e.g., network(s) 831). The communication interface 830 can include, for example, one or more of a communications controller, receiver, transceiver, transmitter, port, conductors, software and/or hardware for communicating data.

The third-party entity computing system 835 can include one or more computing device(s) 840 that are remote from the service entity computing system 805 and/or the autonomous vehicle computing system 865. The computing device(s) 840 can include one or more processors 845 and a memory 850. The one or more processors 845 can be any suitable processing device (e.g., a processor core, a microprocessor, an ASIC, a FPGA, a controller, a microcontroller, etc.) and can be one processor or a plurality of processors that are operatively connected. The memory 850 can include one or more tangible, non-transitory computer-readable storage media, such as RAM, ROM, EEPROM, EPROM, one or more memory devices, flash memory devices, data registrar, etc., and combinations thereof.

The memory 850 can store information that can be accessed by the one or more processors 845. For example, the memory 850 (e.g., one or more tangible, non-transitory computer-readable storage media, one or more memory devices, etc.) can include computer-readable instructions 851 that can be executed by the one or more processors 845. The instructions 851 can be software written in any suitable programming language or can be implemented in hardware. Additionally, or alternatively, the instructions 851 can be executed in logically and/or virtually separate threads on processor(s) 845.

For example, the memory 850 can store instructions 851 that when executed by the one or more processors 845 cause the one or more processors 845 to perform operations such as any of the operations and functions of the third-party entity computing system (or for which it is configured), one or more of the operations and functions for communicating between a third-party entity and/or a service entity and/or an autonomous vehicle, one or more portions of methods 400, 500, and 600, and/or one or more of the other operations and functions of the computing systems described herein.

The memory 850 can store data 852 that can be obtained. The data 852 can include, for example, data associated with communications (e.g., messages, calls, callbacks, etc.), data associated with software package(s) (e.g., Cloud SDK data), data associated with one or more backends, data associated with a Public VIP, batched data, data associated with VIDs, data associated with vehicle registration, data associated with a registration authority, data associated with a certificate authority, data associated with security certificates, data associated with autonomous vehicles, data associated with third-party entities, sensor data, map data, vehicle state data, vehicle location data, perception data, prediction data, motion planning data, data associated with a vehicle client, data associated with a communication network, data associated with an API, data associated with a library, data associated with user interfaces, data associated with user input, and/or other data/information such as, for example, that described herein.

The computing device(s) 840 can also include a communication interface 860 used to communicate with one or more system(s) onboard an autonomous vehicle and/or another computing device that is remote from the system 835, such as autonomous vehicle computing system 865 and service entity computing system 805. The communication interface 860 can include any circuits, components, software, etc. for communicating via one or more networks (e.g., network(s) 831). The communication interface 860 can include, for example, one or more of a communications controller, receiver, transceiver, transmitter, port, conductors, software and/or hardware for communicating data.

The autonomous vehicle computing system 865 can include one or more computing device(s) 870 that are remote from the service entity computing system 805 and the third-party entity computing system 835. The computing device(s) 870 can include one or more processors 875 and a memory 880. The one or more processors 875 can be any suitable processing device (e.g., a processor core, a microprocessor, an ASIC, a FPGA, a controller, a microcontroller, etc.) and can be one processor or a plurality of processors that are operatively connected. The memory 880 can include one or more tangible, non-transitory computer-readable storage media, such as RAM, ROM, EEPROM, EPROM, one or more memory devices, flash memory devices, data registrar, etc., and combinations thereof.

The memory 880 can store information that can be accessed by the one or more processors 875. For example, the memory 880 (e.g., one or more tangible, non-transitory computer-readable storage media, one or more memory devices, etc.) can include computer-readable instructions 881 that can be executed by the one or more processors 875. The instructions 881 can be software written in any suitable programming language or can be implemented in hardware. Additionally, or alternatively, the instructions 881 can be executed in logically and/or virtually separate threads on processor(s) 875.

For example, the memory 880 can store instructions 881 that when executed by the one or more processors 875 cause the one or more processors 875 to perform operations such as any of the operations and functions of the autonomous vehicle computing system (or for which it is configured), one or more of the operations and functions for communicating between a third-party entity and/or a service entity and/or an autonomous vehicle, one or more portions of methods 400, 500, and 600, and/or one or more of the other operations and functions of the computing systems described herein.

The memory 880 can store data 882 that can be obtained. The data 882 can include, for example, data associated with communications (e.g., messages, calls, callbacks, etc.), data associated with software package(s) (e.g., Cloud SDK data), data associated with one or more backends, data associated with a Public VIP, batched data, data associated with VIDs, data associated with vehicle registration, data associated with a registration authority, data associated with a certificate authority, data associated with security certificates, data associated with autonomous vehicles, data associated with third-party entities, sensor data, map data, vehicle state data, vehicle location data, perception data, prediction data, motion planning data, data associated with a vehicle client, data associated with a telecommunication network, data associated with an API, data associated with a library, data associated with user interfaces, data associated with user input, and/or other data/information such as, for example, that described herein.

The computing device(s) 870 can also include a communication interface 890 used to communicate with one or more system(s) onboard a vehicle and/or another computing device that is remote from the system 865, such as third-party entity computing system 835 and/or service entity computing system 805. The communication interface 890 can include any circuits, components, software, etc. for communicating via one or more networks (e.g., network(s) 831). The communication interface 890 can include, for example, one or more of a communications controller, receiver, transceiver, transmitter, port, conductors, software and/or hardware for communicating data.

The network(s) 831 can be any type of network or combination of networks that allows for communication between devices. In some implementations, the network(s) 831 can include one or more of a local area network, wide area network, the Internet, secure network, cellular network, mesh network, peer-to-peer communication link and/or some combination thereof and can include any number of wired or wireless links. Communication over the network(s) 831 can be accomplished, for example, via a communication interface using any type of protocol, protection scheme, encoding, format, packaging, etc.

Computing tasks, operations, and functions discussed herein as being performed at one computing system herein can instead be performed by another computing system, and/or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

The communications between computing systems described herein can occur directly between the systems or indirectly between the systems. For example, in some implementations, the computing systems can communicate via one or more intermediary computing systems. The intermediary computing systems may alter the communicated data in some manner before communicating it to another computing system.

The number and configuration of elements shown in the figures is not meant to be limiting. More or less of those elements and/or different configurations can be utilized in various embodiments.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method for communication between a service entity and a third-party entity, comprising:
accessing, by a first computing system comprising one or more computing devices, a software package stored within the first computing system, wherein the first computing system is associated with a third-party entity, wherein the third-party entity is associated with one or more autonomous vehicles, and wherein the software package is associated with a service entity that coordinates a vehicle service for the one or more autonomous vehicles;
establishing, by the first computing system via the software package, a communication connection with a second computing system that is associated with the service entity, wherein the second computing system comprises one or more backend services to facilitate the vehicle service; and
communicating, between the first computing system and the second computing system, data indicative of a communication associated with the one or more autonomous vehicles via the communication connection.

2. The computer-implemented method of claim 1, wherein the data indicative of the communication associated with the one or more autonomous vehicles comprises data associated with a vehicle identifier for at least one of the one or more autonomous vehicles.

3. The computer-implemented method of claim 1, wherein the one or more autonomous vehicles comprise a plurality of autonomous vehicles, the method further comprising:
obtaining, by the first computing system or the second computing system, data associated with the plurality of autonomous vehicles; and
batching, by the respective computing system, the data associated with the plurality of autonomous vehicles to generate the data indicative of the communication associated with the one or more autonomous vehicles.

4. The computer-implemented method of claim 1, wherein the data indicative of the communication associated with the one or more autonomous vehicles comprises data associated with registration of the one or more autonomous vehicles.

5. The computer-implemented method of claim 1, wherein the data indicative of the communication associated with the one or more autonomous vehicles comprises data associated with a security certificate of the one or more autonomous vehicles.

6. The computer-implemented method of claim 5, wherein the software package is configured to act as a security delegate for the one or more autonomous vehicles.

7. The computer-implemented method of claim 1, wherein the data indicative of the communication associated with the one or more autonomous vehicles comprises data associated with at least one of one or more vehicle states, one or more calls, or one or more callbacks;
wherein the one or more states comprise an online state or an offline state;
wherein the one or more calls comprise one or more actions for the one or more autonomous vehicles; and
wherein the one or more callbacks comprise one or more updates from the one or more autonomous vehicles.

8. The computer-implemented method of claim 1, wherein establishing, by the first computing system via the software package, the communication connection with the second computing system that is associated with the service entity comprises establishing the communication connection via a core layer of the software package.

9. The computer-implemented method of claim 1, wherein communicating, between the first computing system and the second computing system, the data indicative of the communication associated with the one or more autonomous vehicles via the communication connection comprises communicating the data indicative of the communication via a business layer of the software package.

10. The computer-implemented method of claim 1, wherein prior to communicating, between the first computing system and the second computing system, data indicative of the communication associated with the one or more autonomous vehicles, the method further comprises:
receiving, by the first computing system, the data indicative of the communication from the one or more autonomous vehicles.

11. The computer-implemented method of claim 1, wherein communicating, between the first computing system and the second computing system, the data indicative of the communication associated with the one or more autonomous vehicles via the communication connection comprises transmitting the data indicative of the communication from the first computing system to the second computing system.

12. The computer-implemented method of claim 1, wherein communicating, between the first computing system and the second computing system, the data indicative of the communication associated with the one or more autonomous vehicles via the communication connection comprises transmitting the data indicative of the communication from the second computing system to the first computing system.

13. A communication system for enabling communication between a service entity and an autonomous vehicle associated with a third-party entity, comprising:
a first computing system associated with the third-party entity, the first computing system comprising one or more processors and one or more memory devices, the first computing system further comprising a software package associated the service entity; and
a second computing system associated with the service entity, the second computing system comprising one or more processors and one or more memory devices, the second computing system further comprising a vehicle integration platform comprising a plurality of application programming interfaces, each of the plurality of application programming interfaces configured to provide one or more backend services to facilitate one or more vehicle services;
wherein the first computing system is configured to perform operations, the operations comprising:
accessing the software package;
establishing a communication connection between the first computing system and the second computing system via the software package;
receiving a message from the vehicle integration platform via the communication connection, the message comprising at least one vehicle identifier associated with at least one particular autonomous vehicle associated with the third-party entity; and
communicating the message to the at least one particular autonomous vehicle.

14. The communication system of claim 13, wherein the software package comprises one or more libraries with one or more previously-exposed application programming interfaces which have been integrated into the backend of the first computing system.

15. The communication system of claim 13, wherein the message comprises a call to the at least one particular autonomous vehicle, the call comprising one or more of: instructions for the at least one particular autonomous vehicle to come online, instructions for the at least one particular autonomous vehicle to go offline, a trip offer, a request for the at least one particular autonomous vehicle's location, instructions to begin a trip, instructions to finish a trip, instructions to perform a stop, instructions to cancel a trip, instructions to position the at least one particular autonomous vehicle at a particular location, or one or more utility commands.

16. The communication system of claim 13, wherein the message comprises a batched message comprising a plurality of messages for a plurality of autonomous vehicles associated with the third-party entity, each message in the plurality comprising a vehicle identifier associated with at least one particular autonomous vehicle of the plurality of autonomous vehicles; and
wherein communicating the message to the at least one particular autonomous vehicle comprises communicating each respective message in the plurality of messages to the at least one particular autonomous vehicle associated with the vehicle identifier of the respective message.

17. A cloud-based software package for communication between a service entity and an autonomous vehicle associated with a third-party, the software package comprising one or more tangible, non-transitory, computer-readable media that store instructions that when executed by one or more processors cause the one or more processors to perform operations, the operations comprising:
receiving a message from the autonomous vehicle associated with the third-party entity;
determining whether an open communication connection associated with the service entity and the autonomous vehicle is established;
when the open communication connection associated with the service entity and the autonomous vehicle is established, transmitting, via the open communication connection, the message to the service entity; and
when the open communication connection associated with the service entity and the autonomous vehicle is not established, establishing, via the software package, a new communication connection associated with the service entity and the autonomous vehicle; and
transmitting, via the new communication connection, the message to the service entity.

18. The cloud-based software package of claim 17, wherein the operations further comprise:
signing the message with a security certificate on behalf of the autonomous vehicle.

19. The cloud-based software package of claim 17, wherein the message comprises one or more callbacks from the autonomous vehicle to the service entity, the one or more callbacks comprising one or more of: a notification that the autonomous vehicle is coming online for trips or supply positioning, a notification that the autonomous vehicle is going offline for trips or supply positioning, a trip cancellation, an acceptance or a rejection of a trip offer, a location of the autonomous vehicle, or a notification of a completion of a task at a waypoint.

20. The cloud-based software package of claim 17, wherein transmitting the message to the service entity via the open communication connection or the new communication connection comprises transmitting the message to a vehicle integration platform associated with the service entity.
